(19) United States
(12) Patent Application Publication
(10) Pub. No.: US 2006/0178987 A1
(43) Pub. Date: Aug. 10, 2006

(54) Systems and methods for re-amortizing a borrower's monthly payment for collection and payment to a lender

(76) Inventor: Eric Ostergren, Midland, MI (US)

Correspondence Address: SUTHERLAND ASBILL & BRENNAN LLP, 999 PEACHTREE STREET, N.E., ATLANTA, GA, 30309, US

(21) Appl. No.: 11/327,673

(22) Filed: Jan. 5, 2006

Related U.S. Application Data
(60) Provisional application No. 60/647,279, filed on Jan. 26, 2005.

(51) Int. Cl. G06Q 40/00

(52) U.S. Cl. 705/40

(57) ABSTRACT

Systems and methods for re-amortizing a borrower's monthly payments for collection and payment to a lender. The method includes determining an electronic payment term cycle, which includes one or more of monthly payment cycles and each monthly payment cycle includes one or more collection days periodically occurring according to a collection cycle. An optimal derivative payment is then determined based on a monthly payment of the original loan, the loan term, and the electronic payment term cycle. The optimal derivative payment is withdrawn from an account associated with the borrower on a collection day and is placed into a separate account. A deposit is also placed into the separate account, where the deposit amount is diminished at a rate based on the electronic payment term cycle. A payment is then made to the lender on the payment date of the original loan from the funds accumulated in the separate account.

### RELATED APPLICATION

This application relates to, and claims the benefit of, U.S. Provisional Patent Application Ser. No. 60/647,279 entitled “System and Method for Re-amortizing a Borrower's Monthly Payment for Collection and Payment to the Lender,” filed on Jan. 26, 2005, which is incorporated by reference herein.

### FIELD OF THE INVENTION

The present invention generally relates to the re-amortization of loans.

### BACKGROUND OF THE INVENTION

In recent times, the means for an efficient collection process of loan payments has emerged utilizing electronic fund transfers (EFTs), however, even though EFTs are becoming more popular, many financial institutions do not utilize EFTs as a means of payment collection, and if they do, most still amortize and collect payments on a monthly basis. Moreover, approximately 85% of the US population is paid either weekly or bi-weekly, however, nearly 100% of all loans and/or leases are amortized and repaid on a monthly basis. This has presented problems to borrowers who have difficulty in aligning their payments within their budget (i.e., pay periods) and frequently payments may be missed, forgotten and/or are difficult to make and/or manage.

With the advent of the Internet and the Federal Reserve's methods for accessing the Automated Clearing House (ACH), EFT payment systems have become popular as a convenient way to collect and pay mortgage payments. Traditional EFT payment systems divide a normal monthly payment in half and electronically collect them from a customer's checking account every two weeks and store the payment in a “Separate Account” until the regular Monthly Payment is due and is then paid. This traditional method yields an additional full payment that is applied to the principal because there are twenty-six (26) bi-weekly periods each year or thirteen (13) full monthly payments. These traditional EFT payment systems reduce the the interest paid and the term of the loan significantly (e.g., a 30 year mortgage can be paid off in 22 years, saving tens of thousands of dollars in interest). The major shortcoming of traditional EFT systems is the negative impact on the consumer's payment stream. This methodology has enabled consumers to save interest while building additional equity in their home.

Traditional EFT systems for retailers/lenders of large ticket items like automobiles have also been attempted but with limited success because loan terms are shorter, yielding limited interest savings which reduces the appeal to the customer. The extra amounts collected have a negative impact on the customer's purchasing power due to the extra amounts collected each month. Additionally, the consumer is typically charged a non-refundable enrollment fee. With the average automobile loan today, the enrollment fee alone may exceed the total interest saved prepaying principal and decreasing the loan term. Retailers/lenders are constantly looking for competitive advantages in the marketplace including offering more attractive financing options to their customers. They also want to make it easier for their customers to buy their products and earn additional income in helping them finance their products.

Most traditional EFT systems are processed by Third Party Administrators (TPAs) who act as agents for their customers and collect EFT debits from the customer's checking account which are then paid to the lender when the customer's Monthly Payment is due. Because often lenders do not want loans paid off early with additional principal payments reducing loan profits as described above, an adversarial relationship has existed between traditional TPAs and the lender. Also, applying an extra principal payment to a loan creates an additional administrative processing cost for the lender. Lenders want payments to be paid “on time” and not ahead of time and in the specified contracted amount, although, in some circumstances, they must accept and apply additional principal payments. The existing adversarial relationship between the lenders and the TPAs has limited access in obtaining the customers loan numbers necessary to apply payments to the proper loan account which has caused problems for the customer at the onset of the fiduciary relationship. Traditional EFT bi-weekly systems have not been able to overcome these problems. Moreover, the US banking system is designed utilizing a monthly amortization/payment structure and changing that infrastructure would cost billions in upgrading costs and ongoing billions in additional payment processing costs.

Still, lenders want to receive payments on the specified monthly due date and reduce payment processing costs and loan defaults, without affecting the normal finance/lease term and paying additional principal, which reduces profits. At the same time consumers want and need affordable payments that align more closely with the way they are paid and convenient ways to pay them (i.e. EFT withdrawals), and ways to improve their payment stream.

### SUMMARY OF THE INVENTION

According to an embodiment of the invention, there is disclosed a method for re-amortizing a borrower's monthly payments for collection and payment to a lender. The method includes determining an electronic payment term cycle (TC), where the term cycle includes one or more monthly payment cycles and each monthly payment cycle includes one or more collection days periodically occurring according to a collection cycle. The method further includes determining an optimal derivative payment based on at least the monthly payment associated with the loan (MP), the loan term (LT) and the electronic payment term cycle and withdrawing funds equal to the derivative payment on a collection day. The method also includes placing the derivative payment into a separate account; and placing a deposit into the separate account, where the deposit amount is diminished at a rate based on the electronic payment term cycle. The method further includes making a payment to the lender from the funds accumulated in the separate account.

According to one aspect of the invention the deposit is equal to an optimal derivative payment. According to another aspect of the invention the electronic payment term cycle is a bi-weekly term cycle, wherein the bi-weekly term cycle includes any six (6) monthly cycles during the loan term and collection days are 14 days apart. According to yet another aspect of the invention the electronic payment term cycle is a weekly term cycle, wherein the weekly term cycle includes any three (3) monthly cycles during the loan term and collection days are 7 days apart.

Another aspect of the invention includes calculating an optimal derivative payment using the equation: optimal derivative payment=((LT/TC)*MP)*((TC/13)/(LT/TC)). Yet another aspect of the invention includes determining if a loan payment to the lender is due prior to making a payment to the lender from the funds accumulated in the separate account. According to another aspect of the invention the funds accumulated in the separate account earn interest.

Another embodiment of the invention includes a method of for re-amortizing a borrower's monthly payments for collection and payment to a lender that includes determining a loan amount and the loan term; determining an electronic payment term cycle where the electronic payment term cycle is a bi-weekly term cycle, and where the bi-weekly term cycle includes any six (6) monthly cycles during the loan term and collection days are 14 days apart; and determining an optimal derivative payment based on the monthly payment, loan term and electronic payment term cycle.

Another embodiment of the invention includes a system for re-amortizing a borrower's monthly payments for collection and payment to a lender that includes an input device for entering a plurality of customer data to be utilized in a software routine; a database for storing customer data; and a processor functionally coupled to the input device and database and configurable for executing computer executable instructions. Specifically, the computer executable instructions include querying the database to retrieve a loan amount and the loan term; querying the database to determine an electronic payment term cycle where the electronic payment term cycle is a bi-weekly term cycle, and where the bi-weekly term cycle includes any six (6) monthly cycles during the loan term and collection days are 14 days apart; and calculating an optimal derivative payment based on the monthly payment, loan term and electronic payment term cycle. According to one aspect of the invention the customer data includes at least a loan number associated with a customer.

### DESCRIPTION OF THE DRAWINGS

Having thus described the invention in general terms, reference will now be made to the accompanying drawings, which are not necessarily drawn to scale, and wherein:

FIG. 1 is a block diagram illustration of the apparatus which is in accordance with an embodiment of the present invention.

FIG. 2 is an illustration of the method for determining the optimal derivative weekly or bi-weekly debit in accordance with an embodiment of the present invention.

FIG. 3 is an illustration of the bi-weekly funds collection and payment stream in accordance with an embodiment of the present invention compared to a traditional method of funds collection.

FIG. 4 is an illustration of the weekly funds collection and payment stream in accordance with an embodiment of the present invention compared to a traditional method of funds collection.

FIG. 5 is a flow diagram of the decision and enrollment process in accordance with an embodiment of the present invention.

FIG. 6 is a flow diagram of the funds collection and payment process in accordance with an embodiment of the present invention.

### DESCRIPTION OF THE INVENTION

The present invention provides a means of calculating and displaying a smaller optimal derivative weekly or bi-weekly debit for overcoming the shortfalls of the prior art. Specifically, the present invention provides a means to calculate and collect smaller optimal derivative weekly or bi-weekly payments, and then pay the normal Monthly Payments, without affecting the original finance/lease term(s) or having a customer pay additional principal.

The present invention is described below with reference to figures and flowchart illustrations of systems, methods, apparatuses and computer program products according to the embodiments of the invention. It will be understood that each block of the flowchart illustrations, and combinations of blocks in the flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions. The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, Internet based systems, etc.

Application programs that are components of the invention may include routines, programs, components, data structures, etc. that implements certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network.

The present invention will now be described more fully hereinafter with reference to the accompanying figures, in which like numerals indicate like elements throughout the several drawings. Some, but not all embodiments of the invention are described. Indeed, these inventions may be embodied in many different forms and should not be construed as limited to the embodiments set forth herein; rather, these embodiments are provided so that this disclosure will satisfy applicable legal requirements, be thorough and complete, and will fully convey the scope of the invention to those skilled in the art.

The unique software embodiment described restructures Monthly Payments to the optimal fraction thereof, without increasing the customer's payment stream in order to pay the customers regular Monthly Payments, to the nearest penny, throughout the loan term. The derivative debit process is a desirable alternative for customers and lenders to use for many reasons. The process method described herein is a resolution of system deficiencies and takes advantage of new EFT technology, the Internet and the Federal Reserve's Automated Clearing House.

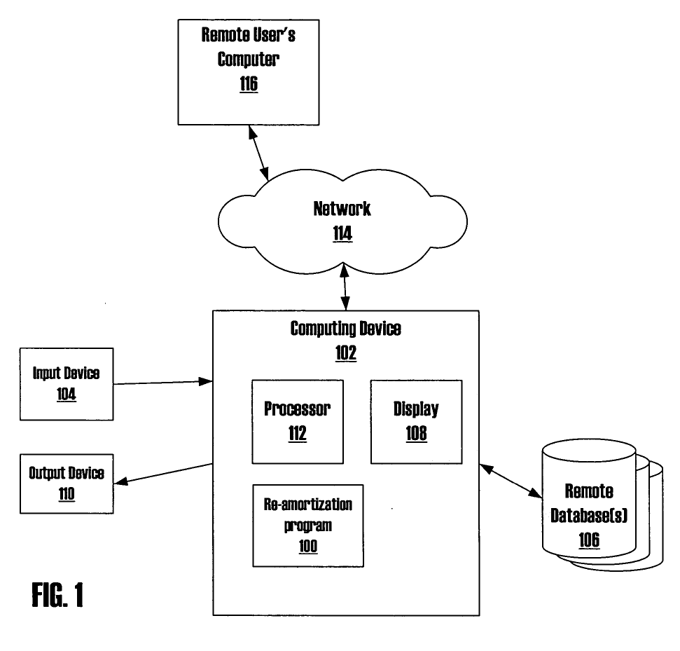

FIG. 1 illustrates a block diagram of the apparatus in accordance with the present invention. The re-amortization program 100 which, in the exemplary embodiment resides in memory on a computer device 102 such as a Personal Computer (PC) with a processor 112, i.e., Central Processing Unit (CPU), or, alternatively, the computer device 102 may be a server or Internet base server where the software is accessible by a remote user's computer 116 via a public or private network 114. The invention also may be practiced with other computer system configurations, including hand-held devices, multiprocessor systems, microprocessor based or programmable consumer electronics, mini-computers, mainframe computers, etc. The computer device 102 also may include or be in communication with a Read Only Memory (ROM) and Random Access Memory (RAM) and user input devices 104 including but not limited to keyboards, scanners, a mouse, audio or video input devices, etc. Other input devices 104 may include connections to other database systems 106 for input or interfacing capabilities. The computer device 102 also may include a monitor or display device 108 such as a monitor that is capable of displaying a graphical user interface. Other Output devices 110 may include printers, fax modems, electronic interfaces to other systems or databases, etc.

The re-amortization program 100 utilized in the various routines described herein may be stored and reside within the computer device 102. The re-amortization program 100 is implemented through an application program running on an operating system of the computer device 102. As will be described below, the software relates to calculating and displaying smaller optimal derivative debits of a Monthly Payment to aid retailers/lenders/borrowers in both the selling of products and the financing or re-financing of those products without affecting the original finance/lease term(s) or paying additional principal.

In an exemplary embodiment of the present invention, the re-amortization program 100 calculates and displays a smaller derivative weekly or bi-weekly debit, which is a fraction of a full, original monthly payment, preserving the integrity of the original loan contract and loan term providing financing and re-financing options to consumers, retailers, and lenders that were previously unavailable. This permits the customer to effectively “re-amortize” their monthly loan obligation into a smaller optimal weekly or bi-weekly debit scheme which has a positive impact on their payment stream and enables customers to make smaller more frequent debits that align more closely with their pay periods. The re-amortization program 100 also enables lenders to maintain their existing monthly loan processes and payment infrastructure systems because debits are collected and paid automatically, reducing loan defaults. Moreover, the re-amortization program 100 may be interfaced into other output devices 110 including third party systems that may have EFT capabilities. These systems may also satisfy government regulatory requirements dealing with the transfer of monetary funds and the protocol thereof.

The calculated optimal derivative debit is determined by several variable factors such that the instructions will execute on a computer or other programmable data processing apparatus as shown in FIG. 1. The figures below describe the various routines and processes that the re-amortization program 100 will be used to carry out.

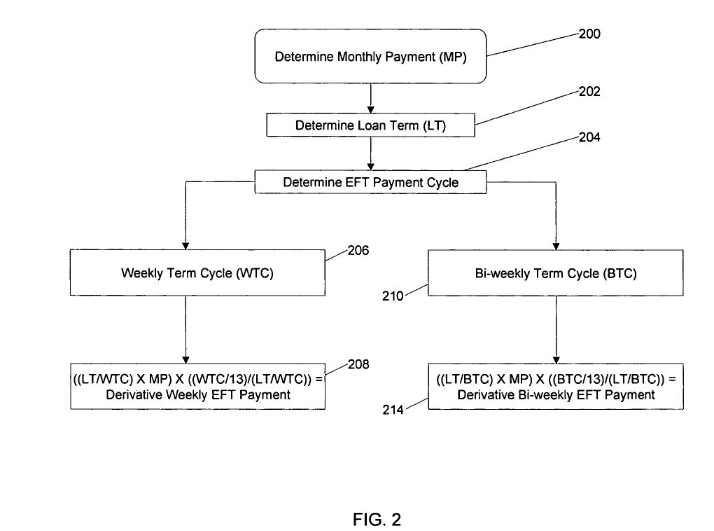

FIG. 2 is an illustration of the method for determining the optimal derivative weekly or biweekly debit in accordance with an embodiment of the present invention. As shown in FIG. 2 a series of steps are to be followed and executed on a computer or other programmable data processing apparatus starting at step 200 where the Monthly Payment (MP) is determined. The MP refers to a normal monthly payment amount. Next, step 202 is invoked to determine the Loan Term (LT). LT refers to the number of monthly cycles in a normal scheduled loan term. A loan term may be made up of term cycles, which are subsets of monthly cycles for the loan term. The next determination is done in step 204, where the desired EFT payment cycle is selected. In the exemplary embodiment of FIG. 2, either a weekly or bi-weekly payment cycle is selected, although alternative embodiments may implement other payment cycle lengths. In the exemplary embodiment shown in FIG. 2, EFT weekly payment cycle refers to a seven (7) day collection cycle, where a collection day occurs every seven days. An EFT bi-weekly payment cycle refers to a fourteen (14) day collection cycle, where a collection day occurs every 14 days. A loan term, with various payment cycles may also be re-amortized in accordance with an alternative embodiment of the invention. If an EFT Weekly Cycle is desired step 206 is invoked to start the calculation of the derivative weekly EFT payment by determining the Weekly Term Cycle (WTC) In the exemplary embodiment shown in FIG. 2, Weekly Term Cycle (WTC) refers to a period of one or more monthly cycles during the loan term. In the exemplary embodiment of FIG. 2 the WTC is 3 monthly cycles. Next, step 208 is invoked to calculate optimal derivative EFT weekly payment (or debit), using the following equation (the number 13 in the equation represents the number of weekly payment cycles in the WTC and may change given a change to the WTC):
Derivative Weekly EFT Payment=((LT/WTC)*MP)*((WTC/13)/(LT/WTC))

If an EFT bi-weekly cycle is desired step 210 is invoked to start the calculation of the derivative bi-weekly EFT payment by determining the Bi-weekly Term Cycle (BTC). In the exemplary embodiment shown in FIG. 2, Bi-weekly Term Cycle (BTC) refers to a period of one or more monthly cycles during the loan term. In the exemplary embodiment of FIG. 2, the BTC refers to six (6) monthly cycles during the loan term. Next, step 212 is invoked to calculate the optimal derivative EFT bi-weekly payment (or debit), using the following equation (the number 13 in the equation represents the number of bi-weekly payment cycles in the BTC, and may change given a change to the BTC):
Derivative Bi-Weekly EFT Payment=((LT/BTC)*MP)*((BTC/13)/(LT/BTC))

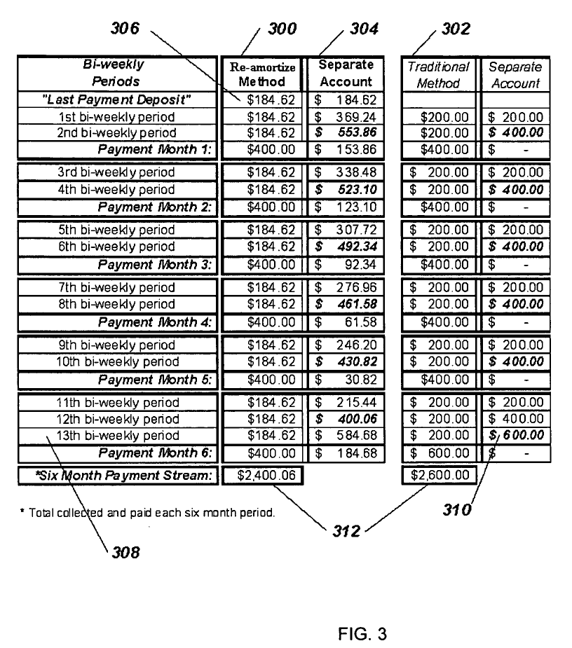

FIG. 3 is an illustration of the bi-weekly funds collection and payment stream in accordance with an embodiment of the present invention compared to a traditional method of funds collection. In an exemplary embodiment of the invention the payment scheme requires the initial optimal derivative debit “last debit deposit” (“deposit”) 306 as an upfront debit. In an alternative embodiment of the invention the initial deposit 306 may be unnecessary due to retailer/lender waiving the deposit such as for a promotion, other any other reason. The deposit 306 is an element of the re-amortization method of the present invention shown in the re-amortize column 300 that enables the regular monthly payment contracts to remain in place without affecting the original finance/lease term or paying additional principal. Traditional methods collect and apply an “extra” bi-weekly debit each six months as an additional principal payment 310, which has a negative impact on the customer's payment stream and causes the loan term length to be shortened. In the present invention, the deposit 306 amount may be used in the “separate account,” column 304 so enough money is available each month to make the monthly payment until the loan is fully paid or terminated.

FIG. 3 illustrates a fourteen (14) day “EFT Bi-weekly Cycle”, which shows six monthly payment cycles and a corresponding payment stream diagram in accordance with an exemplary embodiment of the present invention. The re-amortization method of the present invention shown in the re-amortize column 300 is juxtaposed with the payment stream as shown by the traditional debit method 302. The re-amortize column 300 illustrates the smaller payment stream the present invention embodies and the separate account column 304 shows the cumulative totals of the re-amortization method of the present invention as the monthly payments are made. The number of bi-weekly periods 308 during any bi-weekly term cycle 308 (i.e., six months) is 13. The re-amortization method of the present invention is represented in the re-amortize column 300 also shows that the $400.00 monthly payment is re-amortized to become a $184.62 bi-weekly derivative debit 306, which represents an optimal derivative debit amount needed to minimize the customer's payment stream. In the exemplary embodiment of the invention shown in FIG. 3, the deposit amount 306 ($184.62) is equal to the exact optimal derivative bi-weekly debit amount and is diminished each month by one sixth (i.e., 1/BTC or ⅙) each time the original monthly payment is made. In the exemplary embodiment of the invention the deposit amount 306 is diminished at a rate that is inversely proportional to the given term cycle, in this case, BTC. By the end of the bi-weekly term cycle the thirteenth (13^{th}) EFT bi-weekly cycle, 308, occurs and the “Separate Account” deposit 306 is again replenished by another bi-weekly debit for the next bi-weekly term cycle, until the loan term is complete. The operation of the system implementing this process may accumulate debits to the day and to the penny. Though not required, it is possible to “round up” to the nearest penny because a partial penny cannot be collected. In the traditional method 302 the thirteenth (13^{th}) bi-weekly debit 310 is applied in “Payment Month 6” as an additional principal payment, effectively reducing the loan term. The six month payment stream totals 312 shows the differences in the payment stream of the traditional method 302 and the re-amortization method of the present invention shown in the re-amortize column 300.

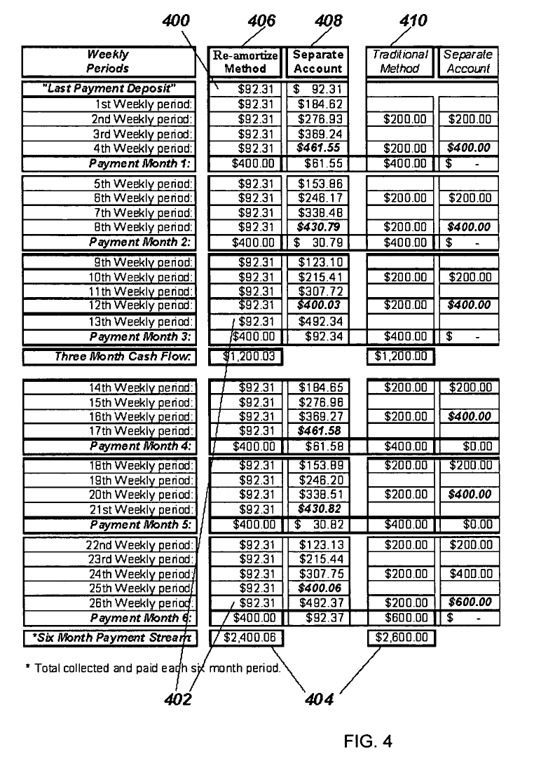

FIG. 4 is an illustration of the weekly funds collection and payment stream in accordance with an embodiment of the present invention (i.e., the re-amortization method of the present invention shown in the re-amortize column 406 compared to a traditional method 410 of funds collection. As shown in FIG. 4, a $400.00 monthly payment is re-amortized and a $92.31 weekly derivative debit is collected. The deposit amount ($92.31) 400, represents the optimal derivative weekly debit amount and is diminished each month by one third (i.e., 1/WTC or ⅓) each time the monthly payment is made. In the exemplary embodiment of the invention the deposit amount 400 is diminished at a rate that is inversely proportional to the given term cycle, in this case, WTC. By the end of the weekly term cycle the thirteenth (13^{th}) weekly derivative debit period occurs and the “Separate Account” deposit 400 is again replenished by another weekly derivative debit 402 for the next weekly term cycle, until the loan term is complete. The six month payment stream totals 404 shows the difference in payment streams between the traditional method 410 and the re-amortization method of the present invention shown in the re-amortize column 406.

In the exemplary embodiment of FIG. 4, when the final weekly or bi-weekly debit in the loan term is reached, the deposit 400 is not replenished, the “Last Debit” is not collected and the final monthly payment is made. Once that has occurred then the account may be closed. In an alternative embodiment, the deposit 400 may not be collected. In such an embodiment the final weekly or bi-weekly debit is collected, the final monthly payment is made and then the account is closed. If the contract is ever prematurely terminated, for any reason, any funds, including the deposit 400 remaining in the customers “Separate Account” may be returned to the customer.

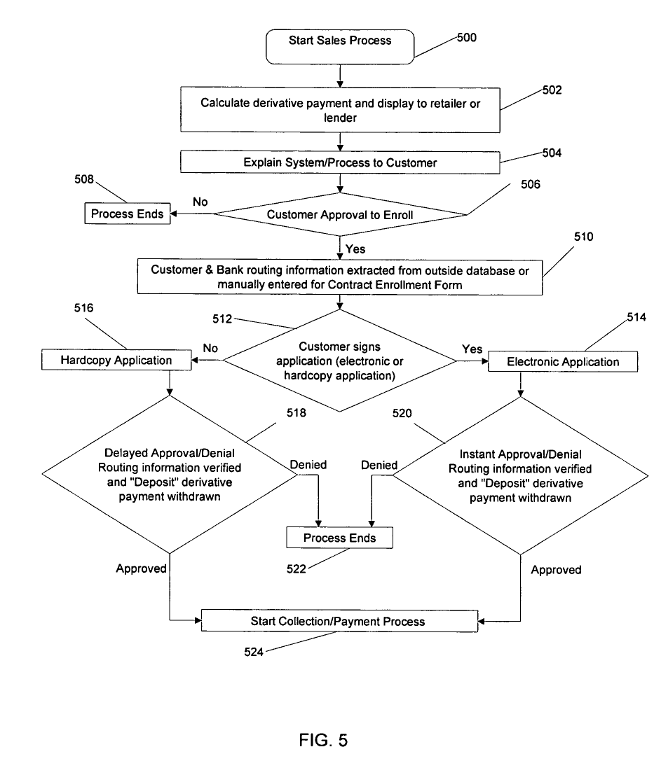

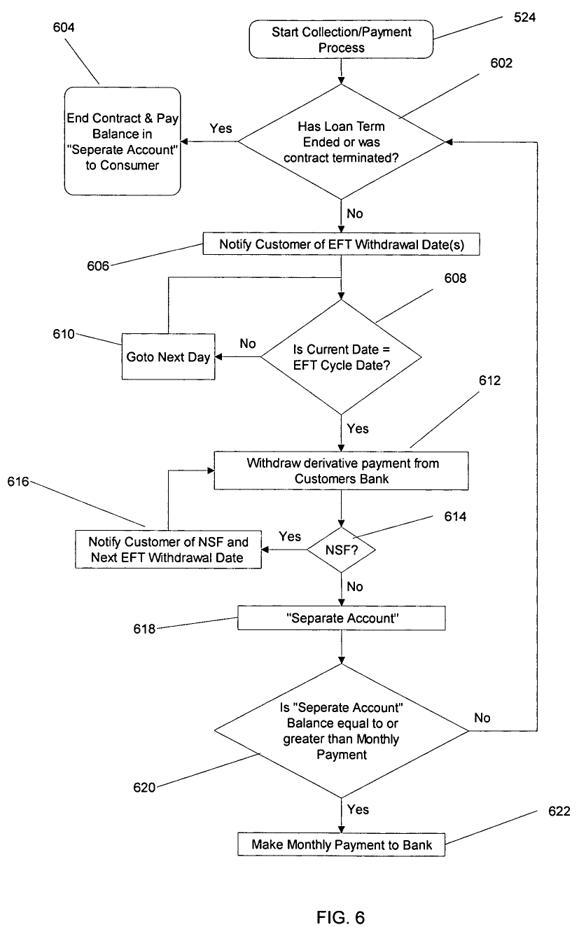

This methodology permits the customer to effectively “re-amortize” their monthly loan obligation into a weekly or bi-weekly loan or any other re-amortization period the customer prefers, while improving their payment stream. This method also allows the lender to maintain their existing monthly loan processes. The exemplary embodiments shown in FIGS. 3 and 4, show how the debit scheme of the present invention improves the customer's payment stream by approximately $200 each six (6) months (or $33.32 per month), versus the traditional bi-weekly method. The systems performing this process will be discussed further below with references to FIGS. 5 and 6.

FIG. 5 illustrates an exemplary embodiment of the point-of-sale enrollment flow processes. The sales process begins at step 500, where financing is to be arranged. Step 502 is invoked to calculate the optimal derivative debit (as discussed with references to FIG. 1 and FIG. 2 above). The Monthly Payment may be manually input or is imported from existing software that may reside on another system utilized by retailers/lenders to calculate Monthly Payments, or may reside on an Internet server. In an exemplary embodiment of the present invention the customer (also referred to as an “applicant”) is then presented with an explanation of the present inventions process in step 504. Additionally, the weekly or bi-weekly optimal derivative debit amount may be displayed on a standard monitor or printed for the retailer/lender to explain the advantages of using the present invention to the customer, usually but not always at the point-of-sale. Step 506 determines if the customer wants to enroll in the program. If the customer declines the program, then step 508 ends the process.

If the customer wants to enroll in the program, step 510 is invoked and the information necessary to enroll the customer in the program is input or imported. The enrollment method may be processed electronically or processed on paper. The information that may be needed for an agreement to be executed may include, but is not limited to, the customers address, phone numbers, bank routing numbers, email addresses, employment information, financial information, etc. As discussed earlier, many retailers/lenders utilize a PC or mini-computer for processing the paperwork, where most, if not all of the customer's information resides. In an exemplary embodiment of the present invention, such information may be electronically imported if the retailer/lender is connected to network capable of retrieving such information and importing it to the software application implementing the steps of FIG. 5. In an alternative embodiment, the only additional information that may be needed is the customer's bank routing numbers all other information may be retrieved from remote databases of systems in communication with the retailer/lender's computer system. The bank routing numbers may be obtained by scanning the customers check with a check-scanner attached to the PC. If a check-scanner is not used, the numbers may be manually inserted into the paperwork by the retailer/lender. Once the customer information is gathered, imported, and/or entered into the software application implementing the steps of FIG. 5, step 512 is invoked to either print the customer agreement for applicant to sign or, alternatively present the application in electronic form and having the applicants provide electronic signatures if that technology is utilized.

If an electronic method is used and the application is electronically authorized, then step 514 is invoked to electronically send the application to step 520, which determines if the agreement is to be accepted or denied. The determination may be based on a variety of factors including credit reports, histories, scores, and other factors appreciable by one of ordinary skill in the art. If an electronic process is utilized the approval process may be made quickly. If an electronic method is not utilized, then step 516 is invoked and a hardcopy application is processed. Steps 516 and 518 may take more time to complete than steps 514 and 520 because the agreement may have to be faxed or mailed and the data may have to be scanned or manually entered in the billing system. Step 518 or step 520 (depending on whether the application is being processed electronically or by manual processing), also determines if the application is accepted or denied. In an exemplary embodiment of the present invention, if the application is approved, the deposit may be collected as part of the approval process. In alternative embodiments of the present invention the deposit collection process of step 518 or 520 is not required to happen immediately after approval (or as part of the approval process). The collection may be delayed depending on the retailer/lender/customer relations, special promotions, etc. In other alternative embodiments, a deposit may not be collected at all.

If the agreement is not accepted, then step 522 ends the process for that particular applicant. The agreement may be denied for several reasons including a returned debit for Non Sufficient Funds (NSF) in the customer's checking account (which may occur during collection of the deposit), or if the customer information was not obtained or entered properly, etc. If the agreement is accepted then step 524 is invoked and the collection/payment process begins.

When implementing the debit scheme outlined in the present invention it is possible, though not necessary, to require the initial optimal derivative debit (“Last Debit Deposit” or “Deposit”) as an upfront debit or as part of the approval process. In accordance with an exemplary embodiment of the present invention, the initial optimal derivative debit (“Last Debit Deposit” or “Deposit”) is collected from the customer's checking account for storage in the customer's separate account. The separate account acts as a repository for the customer's deposit and all derivative debits collected which enables the borrower to re-amortize their monthly payments with smaller derivatives, improving their payment stream. The deposit amount is used in the separate account so enough money is available each month to make the original monthly payment until the loan is fully paid or terminated. However, in alternative embodiments of the present invention, the lender may waive the deposit, depending on the customer's credit worthiness, or for any reason. An alternative embodiment of the deposit may include the creation of a or “phantom” debit deposit whereby the deposit is never collected but appears as if it was collected in the customer's “separate account” to be collected when the “Last Debit” is due. Additionally, retailers may provide the deposit amount for the customer as a promotional or regular feature of the sales process.

FIG. 6 illustrates the embodiment of the collection and payment flow processes. The embodiment of the present invention may reside on a PC, server, networked computer or other device. As shown in FIG. 6, as soon as the collection/payment process is activated in step 524, step 602 is invoked to electronically check on a daily basis (or more/less frequently), the customer's contract status to verify if the loan term has matured or if the contract has been terminated or is inactive. If the contract is inactive, step 604 is invoked and any residual balance in the customer's separate account may be forwarded to the customer and the process ends. If the contract is active, step 606 is invoked and the customer is notified of the scheduled EFT withdrawal dates, which in accordance with the exemplary embodiments of FIGS. 3 and 4, will take place every fourteen (14) days (for a biweekly contract) or every seven (7) days (for a weekly contract). Other EFT collection dates may also be implemented in alternative embodiments of the invention. Electronic mail (email) may be utilized for notifying customers about their accounts; however, the notification may also take place by mail, phone, or other communication means. If the customer's email address is obtained, the customer may also be notified each time an EFT will take place if such notification is desired by the customer. If the notification is made by regular mail, a schedule may be sent one time showing all the scheduled dates for EFTs. However, additional notifications may be sent at the lender/vendor's discretion.

Next, step 608 is invoked daily (or more/less frequently) to check the customer's scheduled EFT withdrawal date. If the debit is due to be collected on that date, step 612 initiates the EFT process. If the current date is not the customer's scheduled EFT due date, then step 610, is invoked. If the current date is a scheduled EFT Due Date, step 614 attempts to withdraw the scheduled EFT amount due from the customers account. If the funds are available, the debit is collected and step 618 is invoked to store the debit in the corresponding customer's separate account, where it is held until the original monthly payment is due. In alternative embodiments of the present invention the funds residing in the customer's separate account may be interest bearing (or invested in a interest bearing investment vehicle or instrument) at the discretion of the lender or as a condition of the agreement. If the EFT process is unsuccessful in withdrawing the funds on that date, step 616 is invoked and the EFT may be attempted at a later date. If all attempts fail, funds will not be available to make the monthly payment and it will not be paid. At that point, the agreement may be terminated and any funds remaining in a customer's separate account will be forwarded to the customer and the customer will be responsible to pay their monthly payment themselves from that point forward.

Each day, step 620 checks the customer's separate account holdings (or more/less frequently) to verify if the balance is large enough to make a monthly payment to the lender. If the balance is equal to or exceeds the monthly payment, step 622 is invoked to forward the monthly payment to the lender, step 622. If the holdings in the customer's separate account are less than a monthly payment, the process starts again at step 602 the next day. The process repeats itself each day until the loan is fully paid or the contract is terminated. In accordance with an exemplary embodiment of the present invention, any funds remaining in the separate account when the loan is terminated are refunded to the customer. Additional fees may be charged depending on the actions of the customer (NSF's, etc.), if so stipulated in the customer agreement.

Prior to the payment of any monthly payment, it may be necessary for the third party administrator (TPA) to obtain the customer's loan number in order to properly apply the monthly payment due the lender to the correct loan account, step 622. If the proper loan number is not obtained, the monthly payment may not be made to the lender even though the funds have been collected from the customer.

The advantages the present invention offers the lender (i.e. customer loans will not be adversely affected and are repaid on time, not ahead of time, etc) may encourage cooperation between the TPA and lender. Lenders also may be able to accept Monthly Payments electronically from the TPA which may reduce the lenders payment processing costs. Additionally, lenders may realize a reduction in defaults because customers will find it easier to make smaller derivative weekly or biweekly debits on time. All these reasons will encourage cooperation between the lender and the TPA. Additionally, the present invention as shown in FIGS. 5 & 6 may not be affected by the extra day per year that accumulates (due to 365 not being divisible by 7 or 14) or the extra day every leap year. In fact the extra days may benefit the system and the customer. Also, weekends and holidays may not affect the operation of the debit system. Users of the present invention, such as automobile dealers and other purveyors/financiers of other small or large ticket items, will be able to quote smaller, more manageable optimal debits to their prospective customers, increasing sales opportunities and attracting new customers. Moreover, the ability to quote weekly or biweekly debits will further enhance their ability to attract these potential customers.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for re-amortizing a borrower's monthly payments for collection and payment to a lender comprising:
determining an electronic payment term cycle (TC), wherein the term cycle includes a plurality of monthly payment cycles and each monthly payment cycle includes a plurality of collection days periodically occurring according to a collection cycle;
determining a derivative payment based on at least the plurality of monthly payment (MP) associated with the loan, the loan term (LT) and the electronic payment term cycle;
withdrawing funds equal to the derivative payment on a collection day;
placing the derivative payment into a separate account;
placing a deposit into the separate account where the deposit amount is diminished at a rate based on the electronic payment term cycle; and
initiating a payment to the lender from the funds accumulated in the separate account.

2. The method of claim 1, wherein the deposit is equal to an optimal derivative payment.

3. The method of claim 1, wherein the electronic payment term cycle is a bi-weekly term cycle, wherein the bi-weekly term cycle includes any six (6) monthly cycles during the loan term and collection days are 14 days apart.

4. The method of claim 1, wherein the electronic payment term cycle is a weekly term cycle, wherein the weekly term cycle includes any three (3) monthly cycles during the loan term and collection days are 7 days apart.

5. The method of claim 1, wherein determining an optimal derivative payment includes calculating the derivative payment using the equation:
Optimal Derivative Payment=((LT/TC)*MP)*((TC/13)/(LT/TC))

6. The method of claim 1, further comprising determining if a loan payment to the lender is due prior to making a payment to the lender from the funds accumulated in the separate account.

7. The method of claim 1, wherein the funds accumulated in the separate account earn interest.

8. A method of for re-amortizing a borrower's monthly payments for collection and payment to a lender comprising:
determining a loan amount and the loan term;
determining an electronic payment bi-weekly term cycle, wherein the electronic payment term cycle is a bi-weekly term cycle, wherein the bi-weekly term cycle includes any six (6) monthly cycles during the loan term and collection days are 14 days apart; and
determining an optimal derivative payment based on the monthly payment, loan term and electronic payment bi-weekly term cycle.

9. A system for re-amortizing a borrower's monthly payments for collection and payment to a lender comprising
an input device for entering a plurality of customer data to be utilized in a software routine;
a database for storing customer data; and
a processor functionally coupled to the input device and database and configurable for executing computer executable instructions for:
querying the database to retrieve a loan amount and the loan term;
querying the database to determine an electronic payment term cycle wherein the electronic payment term cycle is a bi-weekly term cycle, wherein the bi-weekly term cycle includes any six (6) monthly cycles during the loan term and collection days are 14 days apart; and
calculating an optimal derivative payment based on the monthly payment, loan term and electronic payment term cycle.

10. The system of claim 9, wherein the customer data includes at least a loan number associated with a customer.
